(19) United States
(12) Patent Application Publication
(10) Pub. No.: US 2021/0117808 A1
(43) Pub. Date: Apr. 22, 2021

(54) DIRECT-LEARNING AGENT FOR DYNAMICALLY ADJUSTING SAN CACHING POLICY

(71) Applicant: EMC IP HOLDING COMPANY LLC, Hopkinton, MA (US)

(72) Inventors: Vinicius Gottin, Rio De Janeiro (BR); Jonas Dias, Rio De Janeiro (BR); Tiago Calmon, Rio De Janeiro (BR)

(73) Assignee: EMC IP HOLDING COMPANY LLC, Hopkinton, MA (US)

(21) Appl. No.: 16/655,599

(22) Filed: Oct. 17, 2019

(51) Int. Cl. G06N 5/02; G06N 20/00; G06F 16/22; G06F 16/23; G06F 16/21; G06N 5/04

(52) U.S. Cl. CPC G06N 5/02; G06N 20/00; G06N 5/04; G06F 16/2365; G06F 16/212; G06F 16/2237

(57) ABSTRACT

A software agent running on a SAN node performs machine learning to adjust caching policy parameters. Learned cache hit rate distributions and cache hit rate rewards relative to baselines are used to dynamically adjust caching parameters such as prefetch size to improve state features such as cache hit rate. The agent may also detect performance degradation. The agent uses efficient state representations to learn the distribution of hit rates as a function of different caching policy parameters. Baselines are used to learn the difference between the baseline cache hit rate and the cache hit rate under an adjusted caching policy, rather than learning the cache hit rate directly.

### TECHNICAL FIELD

The subject matter of this disclosure is generally related to data storage, and more particularly to SANs (storage area networks).

### BACKGROUND

Data centers are used to maintain large data sets associated with critical functions for which avoidance of data loss and maintenance of data availability are important. A key building block of a data center is the SAN. SANs provide host servers with block-level access to data that is used by applications that run on the host servers. One type of SAN node is a storage array. A storage array may include a network of computing nodes that manage access to arrays of solid-state drives and disk drives. The storage array creates a logical storage device known as a production volume on which host application data is stored. The production volume has contiguous LBAs (logical block addresses). The host servers send block-level IO (input-output) commands to the storage array to access the production volume. The production volume is a logical construct, so the host application data is maintained at non-contiguous locations on the arrays of managed drives to which the production volume is mapped by the computing nodes. SANs have advantages over other types of storage systems in terms of potential storage capacity and scalability. However, no single SAN caching policy provides the best performance for all workloads and configurations.

### SUMMARY

All examples, aspects and features mentioned in this document can be combined in any technically possible way.

In accordance with some implementations a method comprises: with an agent running on a SAN (storage area network) node, adjusting at least one parameter of a caching policy of the SAN node by: generating a record of operation of the SAN node; generating a caching model based on the record; and adjusting the parameter based on the caching model. In some implementations generating the record of operation of the SAN node comprises generating a structured state index. Some implementations comprise updating the structured state index over time, thereby generating an updated structured state index. Some implementations comprise adjusting the parameter based on the caching model and the updated structured state index. In some implementations generating the caching model based on the record comprises obtaining state vectors from the structured state index. In some implementations generating the caching model based on the record comprises generating hit rate distribution vectors from IO traces. In some implementations generating the caching model based on the record comprises building a design matrix that represents a history of access to a production volume. In some implementations generating the caching model based on the record comprises building a target matrix that represents actual hit rate as a function of look-ahead based on simulations. In some implementations generating the caching model based on the record comprises building a matrix that represents predicted hit rate as a function of look-ahead which is compared with the target matrix. In some implementations adjusting the parameter based on the caching model comprises calculating a baseline regularized reward that quantifies a performance improvement in a state feature from adjusting the parameter, choosing a parameter value that maximizes the performance improvement, and outputting an action associated with the chosen parameter.

In accordance with some implementations an apparatus comprises: a SAN (storage area network) node comprising: a plurality of managed drives; a plurality of computing nodes that create a logical production volume based on the managed drives; and a direct-learning agent comprising: instructions that generate a record of operation of the SAN node; instructions that generate a caching model based on the record; and instructions that adjust the parameter based on the caching model. In some implementations the instructions that generate the record of operation of the SAN node comprise instructions that generate a structured state index. Some implementations comprise instructions that update the structured state index over time, thereby generating an updated structured state index. Some implementations comprise instructions that adjust the parameter based on the caching model and the updated structured state index. In some implementations the instructions that generate the caching model based on the record comprise instructions that obtain state vectors from the structured state index. In some implementations the instructions that generate the caching model based on the record comprise instructions that generate hit rate distribution vectors from IO traces. In some implementations the instructions that generate the caching model based on the record comprise instructions that build a design matrix that represents a history of access to a production volume. In some implementations the instructions that generate the caching model based on the record comprise instructions that build a target matrix that represents actual hit rate as a function of look-ahead based on simulations. In some implementations the instructions that generate the caching model based on the record comprise instructions that build a matrix that represents predicted hit rate as a function of look-ahead which is compared with the target matrix. In some implementations the instructions that adjust the parameter based on the caching model comprise instructions that calculate a baseline regularized reward that quantifies a performance improvement in a state feature from adjusting the parameter, choose a parameter value that maximizes the performance improvement, and output an action associated with the chosen parameter.

Other aspects, features, and implementations may become apparent in view of the detailed description and figures.

### BRIEF DESCRIPTION OF THE FIGURES

FIG. 1 illustrates a SAN node with a direct-learning agent for dynamically adjusting the caching policy.

FIG. 2 illustrates operation of the direct-learning of the SAN node of FIG. 1.

FIGS. 3 and 4 illustrate generation of the structured state index in greater detail.

FIGS. 5 and 6 illustrate generation of the caching model in greater detail.

FIG. 7 illustrates adjustment of SAN caching parameters in greater detail.

FIG. 8 illustrates policy parameter adjustment in greater detail.

### DETAILED DESCRIPTION

Aspects of the inventive concepts will be described as being implemented in a data storage system that includes a host server and storage array. Such implementations should not be viewed as limiting. Those of ordinary skill in the art will recognize that there are a wide variety of implementations of the inventive concepts in view of the teachings of the present disclosure.

Some aspects, features, and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory computer-readable medium. Furthermore, it will be understood by those of ordinary skill in the art that the computer-executable instructions may be executed on a variety of tangible processor devices, i.e. physical hardware. For ease of exposition, not every step, device, or component that may be part of a computer or data storage system is described herein. Those of ordinary skill in the art will recognize such steps, devices, and components in view of the teachings of the present disclosure and the knowledge generally available to those of ordinary skill in the art. The corresponding machines and processes are therefore enabled and within the scope of the disclosure.

The terminology used in this disclosure is intended to be interpreted broadly within the limits of subject matter eligibility. The terms “logical” and “virtual” are used to refer to features that are abstractions of other features, e.g. and without limitation abstractions of tangible features. The term “physical” is used to refer to tangible features that possibly include, but are not limited to, electronic hardware. For example, multiple virtual computing devices could operate simultaneously on one physical computing device. The term “logic” is used to refer to special purpose physical circuit elements, firmware, software, computer instructions that are stored on a non-transitory computer-readable medium and implemented by multi-purpose tangible processors, and any combinations thereof.

The following terms in quotation marks have the indicated meanings within this description. A “caching policy” is a group of settings that determine which data to copy into shared memory from managed drives and which data to evict from the shared memory to the managed drives. A “parameterized caching policy” is a caching policy that includes parameters with values that can be adjusted without interrupting regular operation of the SAN. “LRU” (least recently used) is an aspect of a caching policy that causes the least recently used extent of host application data to be evicted from the shared memory when a new extent that is not in the shared memory is the subject of an access operation and the shared memory is “full” in accordance with some predetermined characteristics. A “LRU-look-ahead caching policy” is a caching policy that includes a look-ahead parameter, such as prefetch size, that can be dynamically adjusted. Prefetch size represents the number of additional extents to be retrieved from the managed drives, where the additional extents are contiguously stored (on a production volume or the managed drives) with one or more extents accessed by a given TO command. An extent may be a predetermined basic allocation unit such as a slot or track, for example, and without limitation. Consequently, an TO that accesses a specific slot or track would result in copying that slot or track into shared memory along with the n slots or tracks that are contiguously stored with the accessed slot or track if the prefetch size is n. A “SLRU (segmented LRU) caching policy” is a caching policy in which the shared memory is divided in two regions: probationary and protected. The probationary region is used store extents of host application data that have been requested only once in a given time epoch, whereas the protected region is used to store all other extents. An “alpha parameter” denotes the fraction, ratio or portion of the shared memory reserved for probationary items. The alpha parameter can be dynamically adjusted based on learned access patterns. An “IO trace” or “trace” is a sequence of addresses and lengths that describes sequential accesses to managed drives or a production volume. An “SLRU-look-ahead policy” is a caching policy that includes adjustable look-ahead and alpha parameters.

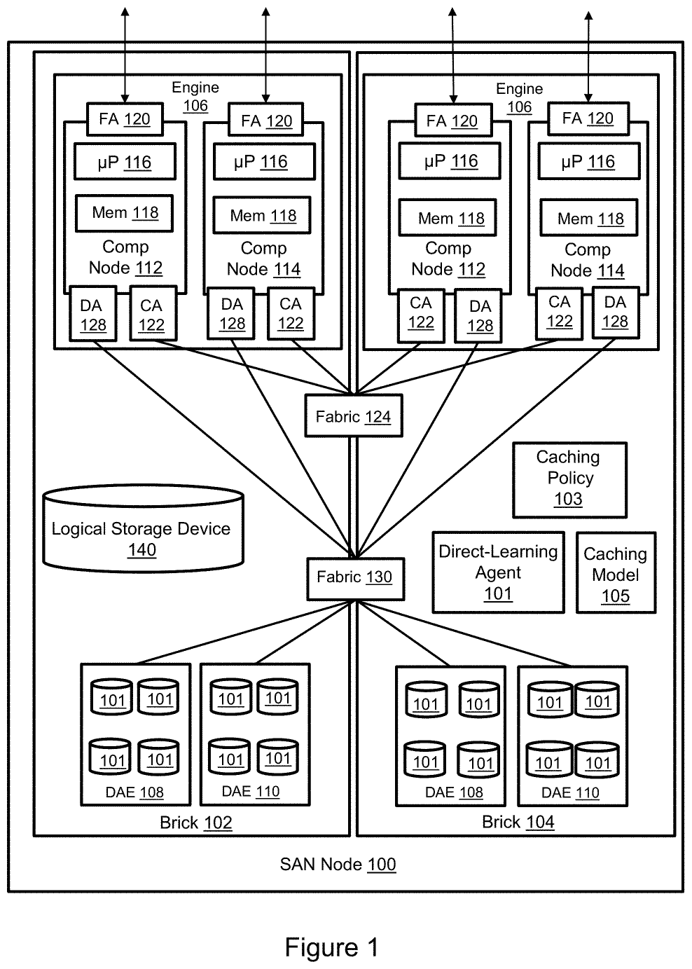

FIG. 1 illustrates a SAN node 100 with a locally run direct-learning agent 101 that generates a caching model 105 of the SAN node and dynamically adjusts parameters of a caching policy 103 of the SAN node based on the caching model. The caching model 105 is custom-made for the SAN node on which the agent is locally run. The SAN node, which may be referred to as a storage array, includes one or more bricks 102, 104. Each brick includes an engine 106 and one or more drive array enclosures (DAEs) 108, 110. Each DAE includes managed drives 101 of one or more technology types. Examples may include, without limitation, solid state drives (SSDs) such as flash and hard disk drives (HDDs) with spinning disk storage media with some known storage capacity. Each DAE might include 24 or more managed drives, but the figure is simplified for purposes of illustration. Each engine 106 includes a pair of interconnected computing nodes 112, 114, which are sometimes referred to as “storage directors.” Each computing node includes at least one multi-core processor 116 and local memory 118. The processor may include CPUs, GPUs, or both, and the number of cores is known. The local memory 125 may include volatile random-access memory (RAM) of any type, non-volatile memory (NVM) such as storage class memory (SCM), or both, and the capacity of each type is known. Each computing node includes one or more front-end adapters (FAs) 120 for communicating with the hosts. The FAs have ports and the hosts may access the SAN node via multiple ports in a typical implementation. Each computing node also includes one or more drive adapters (DAs) 122 for communicating with the managed drives 101 in the DAEs 108, 110. Each computing node may also include one or more channel adapters (CAs) 122 for communicating with other computing nodes via an interconnecting fabric 124. Each computing node may allocate a portion or partition of its respective local memory 118 to a shared memory that can be accessed by other computing nodes, e.g. via direct memory access (DMA) or remote direct memory access (RDMA). The paired computing nodes 112, 114 of each engine 106 provide failover protection and may be directly interconnected by communication links. An interconnecting fabric 130 enables implementation of an N-way active-active backend. A backend connection group includes all DAs that can access the same drive or drives. In some implementations every DA 128 in the storage array can reach every DAE via the fabric 130. Further, in some implementations every DA in the SAN node can access every managed drive 101 in the SAN node. The agents 101 may include program code stored in the memory 118 of the computing nodes and executed by the processors 116 of the computing nodes.

The managed drives 101 are not discoverable by the hosts but the SAN node 100 creates a logical storage device 140 that can be discovered and accessed by the hosts. The logical storage device is used by host applications for storage of host application data. Without limitation, the logical storage device may be referred to as a production volume, production device, or production LUN, where LUN (Logical Unit Number) is a number used to identify the logical storage volume in accordance with the SCSI (Small Computer System Interface) protocol. From the perspective of the hosts the logical storage device 140 is a single drive having a set of contiguous fixed-size logical block addresses (LBAs) on which data used by instances of the host application resides. However, the host application data is stored at non-contiguous addresses on various managed drives 101.

To service IOs from instances of a host application the SAN node 100 maintains metadata that indicates, among various things, mappings between LBAs of the logical storage device 140 and addresses with which extents of host application data can be accessed from the shared memory and managed drives 101. In response to a data access command from an instance of the host application to read data from the production volume 140 the SAN node uses the metadata to find the requested data in the shared memory or managed drives. When the requested data is already present in memory when the command is received it is considered a “cache hit.” When the requested data is not in the shared memory when the command is received it is considered a “cache miss.” In the event of a cache miss the accessed data is temporarily copied into the shared memory from the managed drives and used to service the IO, i.e. reply to the host application with the data via one of the computing nodes. In the case of an IO to write data to the production volume the SAN node copies the data into the shared memory, marks the corresponding logical storage device location as dirty in the metadata, and creates new metadata that maps the logical storage device address with a location to which the data is eventually written on the managed drives. Read and write “hits” and “misses” occur depending on whether the stale data associated with the IO is present in the shared memory when the IO is received. The relationship between hits and misses may be referred to as the “cache hit rate.”

The caching policy 103 is implemented by the computing nodes 112, 114 to determine which data to copy into the shared memory from the managed drives and which data to evict from shared memory to the managed drives. Consequently, the cache hit rate is at least in part a function of the caching policy. Some aspects of the caching policy may be static. For example, the caching policy may always evict the least recently used host application data from the shared memory. Some parameters of the caching policy are adjustable. For example, the prefetch size may be a look-ahead parameter value that indicates the amount of data to be copied from the managed drives into the shared memory in a prefetch operation. A prefetch size value that is too small may result in delays associated with subsequently copying needed non-prefetched data into memory, whereas a prefetch size value that is too large may cause instabilities and performance degradation because of inefficient use of processing and memory resources to prefetch data that isn't needed. Optimal sizing of the prefetch value may vary over time and differ between SAN nodes because of different configurations and time-varying workloads. As will be described below, the direct-learning agent 101 dynamically updates at least some of the adjustable caching policy parameters while the SAN node is in operation.

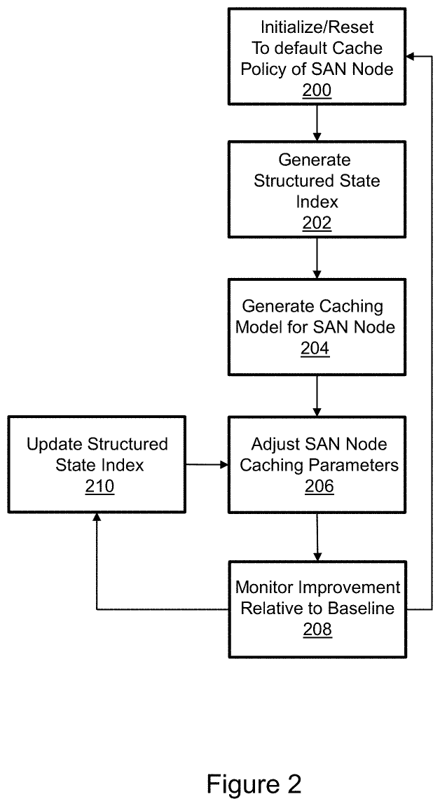

FIG. 2 illustrates operation of the direct-learning agent of the SAN node of FIG. 1. The SAN node may be initialized to a default caching policy as indicated in step 200. Performance under the default caching policy may be considered as a baseline. A structured state index is generated as indicated in step 202. The structured state index is a compact representation of data access patterns that correlates with the dynamically adjusted caching policy parameters. The structured state index is used to generate a deep neural network caching model for the SAN node as indicated in step 204. The caching model is used to compute adjustments to the adjustable SAN node caching policy parameters to improve a performance metric such as the cache hit rate as indicated in step 206. Resulting improvement relative to the baseline is monitored as indicated in step 208. Adjustment of the caching policy parameters is iterated in order to provide incremental improvements and adapt to changing workloads as represented by updating the structured state index as indicated in step 210 and adjusting the parameters in accordance with the updated structured state index using the model. The SAN node may be reset to the default caching policy as indicated in step 200 if performance with updated parameters is unsatisfactory relative to the baseline performance.

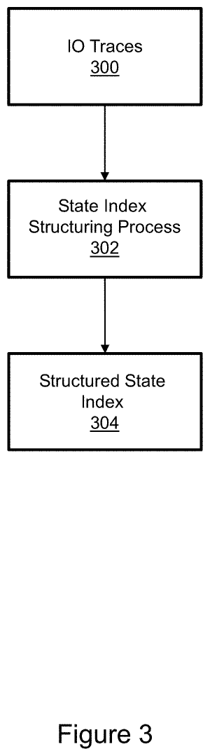

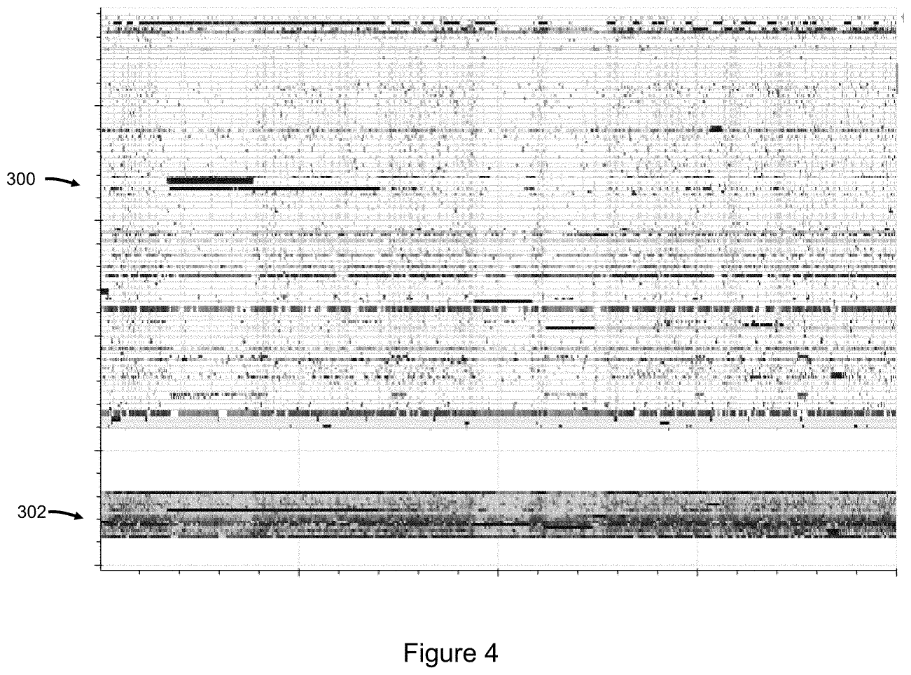

FIGS. 3 and 4 illustrate generation of the structured state index in greater detail. Raw data in the form of IO traces 300 is inputted to a state index structuring process 302.

The state index structuring process 302 extracts meaningful information from the raw data and outputs a structured state index 304 with state features that correlate with adjustable parameters of the caching policy, e.g. a state feature such as cache hit rate that correlates with an adjustable caching policy parameter such as prefetch size. The structured state index is computed periodically, for example once every few seconds or every hundred milliseconds, and each index within the structured state index is a vector describing the operational state of the SAN node at that point in time. As shown in FIG. 4, an index may represent contiguous extents of accessed data and each row in the structured state index may represent a state vector Sₜ. Generation of the structured state index is described in greater detail in U.S. patent application Ser. No. 16/505,767, titled Method and Apparatus for Optimizing Performance of a Storage System, which is incorporated by reference.

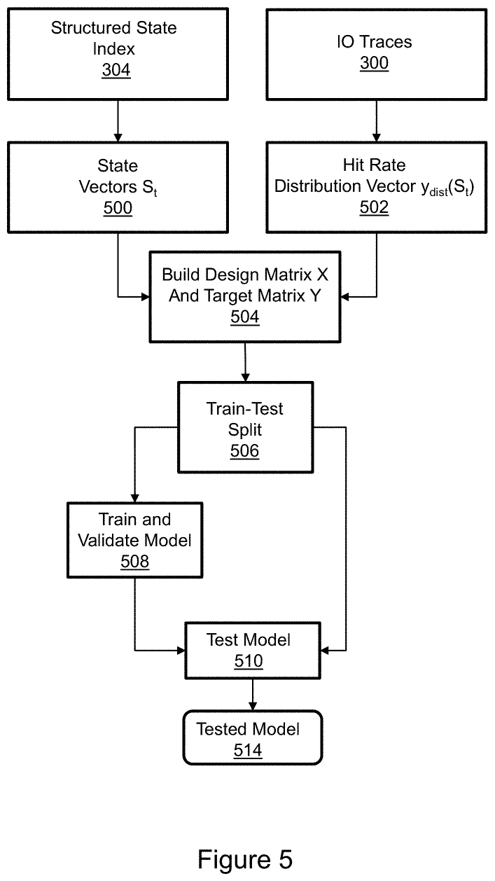

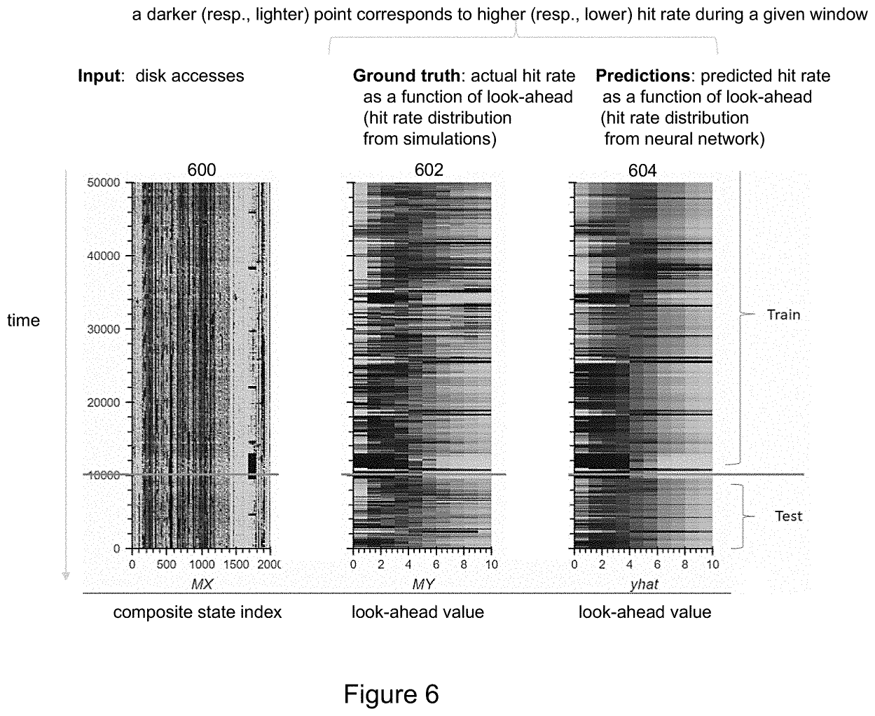

FIGS. 5 and 6 illustrate generation of the caching model in greater detail. State vectors 500 are obtained from the structured state index 304. A hit rate distribution vector 502 is generated from the IO traces 300. Step 504 is to build a design matrix X600 and a target matrix Y 602. Design matrix X represents a history of access to the production volume. In design matrix X each row t is a state vector Sₜ. The target matrix Y represents the “ground truth,” i.e. actual hit rate as a function of look-ahead. In target matrix Y each row is a ground truth hit rate vector ydist(st). In order to build the ground truth matrix, simulations are run on the trace data and the hit rate and/or other parameters are calculated. For each Sₜ we compute the ground truth hit rate vector ydist (Sₜ), where each value in ydist (st) is the expected hit rate for st with the prefetch size set with values 100, 200, 300, . . . , 5000. If we stack the vectors ydist (Sₜ) for all Sₜ we get target matrix Y 602. The available data is then split into training and testing data as indicated in step 506. This enables testing with data that is not learned during training. Step 508 is to train and validate the model. Step 510 is to test the model with the test data. The result is a tested model 514 that may be a Deep Neural Net (DNN) model. The tested model is used to generate predicted hit rate as a function of look-ahead as shown in matrix Ŷ 604. The quality of the trained model can be assessed by comparing matrix Y with matrix Ŷ.

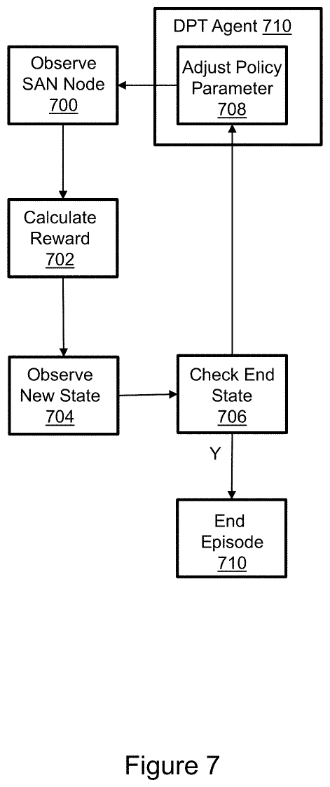

FIG. 7 illustrates adjustment of SAN caching parameters in greater detail. Performance of the SAN node servicing IOs is observed in step 700. Step 700 may have a fixed time duration, or a duration defined by a number or IO operations or other events. Step 702 is to calculate a baseline regularized reward that quantifies a performance improvement in a state feature such as cache hit rate from adjusting a policy parameter such prefetch to a size indicated by the model. Given a baseline cache hit rate b and a measured cache hit rate h, the instantaneous reward r is a function of b and h, r=f(b, h). In some implementations r=h/b or r=h−b. However, more complex functions can be determined based on the application, e.g., by leveraging multiple baselines. After the computation, the computed rewards and metrics are stored. Step 704 is to use data reduction to compute a new state vector Sₜ as a description of the overall state of the IO requests. Step 706 checks for an end state which may be an elapsed time or completion of some number of operations, tasks, or iterations. Step 708 is to adjust a policy parameter in accordance with the model. Step 708 may be implemented by a DPT (direct parameter tuning) agent that is local to the SAN node. The steps are iterated until the end state conditions are satisfied, which leads to an end to the iteration episode as indicated in block 710.

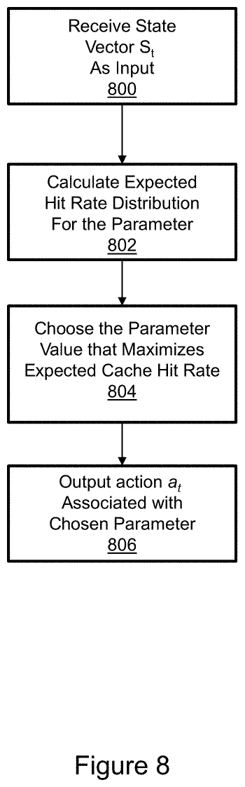

FIG. 8 illustrates policy parameter adjustment by the DPT agent in greater detail. The steps may be implemented by a direct parameter tuning agent. Step 800 is to receive as input the state vector Sₜ. The state vector contains the information about the current and past states of the cache requisitions. Step 804 is to compute the expected hit rate distribution (one hit rate for each cache parameter) using the model. Step 804 is to choose the cache parameter value that maximize the expected hit rate. Step 806 is to output an action aₜ associated with the best parameter. The action may indicate which parameter to adjust, if any, and the value to which the parameter should be set.

Specific examples have been presented to provide context and convey inventive concepts. The specific examples are not to be considered as limiting. A wide variety of modifications may be made without departing from the scope of the inventive concepts described herein. Moreover, the features, aspects, and implementations described herein may be combined in any technically possible way. Accordingly, modifications and combinations are within the scope of the following claims.

What is claimed is:

1. A method comprising:
with an agent running on a SAN (storage area network) node, adjusting at least one parameter of a caching policy of the SAN node by:
generating a record of operation of the SAN node;
generating a caching model based on the record; and
adjusting the parameter based on the caching model by:
calculating a baseline regularized reward that quantifies a performance improvement in a state feature from adjusting the parameter;
choosing a parameter value that maximizes the performance improvement; and
outputting an action associated with the chosen parameter.

2. The method of claim 1 wherein generating the record of operation of the SAN node comprises generating a structured state index.

3. The method of claim 2 comprising updating the structured state index over time, thereby generating an updated structured state index.

4. The method of claim 3 comprising adjusting the parameter based on the caching model and the updated structured state index.

5. The method of claim 2 wherein generating the caching model based on the record comprises obtaining state vectors from the structured state index.

6. The method of claim 5 wherein generating the caching model based on the record comprises generating hit rate distribution vectors from IO traces.

7. The method of claim 6 wherein generating the caching model based on the record comprises building a design matrix that represents a history of access to a production volume.

8. The method of claim 7 wherein generating the caching model based on the record comprises building a target matrix that represents actual hit rate as a function of look-ahead based on simulations.

9. The method of claim 8 wherein generating the caching model based on the record comprises building a matrix that represents predicted hit rate as a function of look-ahead which is compared with the target matrix.

10. An apparatus comprising:
a SAN (storage area network) node comprising:
a plurality of managed drives;
a plurality of computing nodes that create a logical production volume based on the managed drives; and
a direct-learning agent comprising:
instructions that generate a record of operation of the SAN node;
instructions that generate a caching model based on the record; and
instructions that adjust the parameter based on the caching model, comprising:
instructions that calculate a baseline regularized reward that quantifies a performance improvement in a state feature from adjusting the parameter;
instructions that choose a parameter value that maximizes the performance improvement; and
instructions that output an action associated with the chosen parameter.

11. The apparatus of claim 10 wherein the instructions that generate the record of operation of the SAN node comprise instructions that generate a structured state index.

12. The apparatus of claim 11 comprising instructions that update the structured state index over time, thereby generating an updated structured state index.

13. The apparatus of claim 12 comprising instructions that adjust the parameter based on the caching model and the updated structured state index.

14. The apparatus of claim 12 wherein the instructions that generate the caching model based on the record comprise instructions that obtain state vectors from the structured state index.

15. The apparatus of claim 14 wherein the instructions that generate the caching model based on the record comprise instructions that generate hit rate distribution vectors from IO traces.

16. The apparatus of claim 15 wherein the instructions that generate the caching model based on the record comprise instructions that build a design matrix that represents a history of access to a production volume.

17. The apparatus of claim 16 wherein the instructions that generate the caching model based on the record comprise instructions that build a target matrix that represents actual hit rate as a function of look-ahead based on simulations.

18. The apparatus of claim 17 wherein the instructions that generate the caching model based on the record comprise instructions that build a matrix that represents predicted hit rate as a function of look-ahead which is compared with the target matrix.

19. An apparatus comprising:
a SAN (storage area network) node comprising:
a plurality of managed drives;
a plurality of computing nodes that create a logical production volume based on the managed drives; and
a direct-learning agent comprising:
instructions that generate a record of operation of the SAN node comprising instructions that generate a structured state index and update the structured state index over time, thereby generating an updated structured state index;
instructions that generate a caching model based on the record; and
instructions that adjust the parameter based on the caching model, comprising:
instructions that calculate a baseline regularized reward that quantifies a performance improvement in a state feature from adjusting the parameter;
instructions that choose a parameter value that maximizes the performance improvement; and
instructions that output an action associated with the chosen parameter.

20. The apparatus of claim 19 comprising instructions that adjust the parameter based on the caching model and the updated structured state index.
